(19) United States
(12) Patent Application Publication
(10) Pub. No.: US 2009/0224896 A1
(43) Pub. Date: Sep. 10, 2009

(54) METHOD AND SYSTEM FOR INTRUSION DETECTION

(75) Inventor: Danil V. Prokhorov, Canton, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 12/041,708

(22) Filed: Mar. 4, 2008

(51) Int. Cl. B60R 25/10

(52) U.S. Cl. 340/426.28; 340/426.24

(57) ABSTRACT

Provided is a system and method for detecting the presence of an intruder in a vehicle using sensors to measure the change in distance between a portion of the vehicle and the ground. Distance sensors may be placed in a plurality of locations along the vehicle, preferably under the hood where the sensors have a clear line of sight to the ground. A computer is provided to receive the measurements from the sensors to compute a base distance which represents the weight of the vehicle with no intruder. The sensors continue to measure the distance to the ground and the computer subsequently computes a present distance and compares said present distance to said base distance. The computer activates an alarm when the present distance is lesser than the base distance by a predetermined value.

### FIELD OF THE INVENTION

The present invention relates generally to a method for detecting the presence of an intruder in a vehicle. Specifically the invention is directed at achieving such a detection by using relatively low cost short range distance detecting sensors that are known. Such short range distance detecting sensors will detect an intruder by detecting a change in the vehicle's position with respect to the ground.

### BACKGROUND OF THE INVENTION

Various intruder detection systems for automotive vehicles are well documented and known. Such a system is disclosed in U.S. Pat. No. 6,199,904 to Dosdall. The Dosdall patent discloses a system and method for detecting a vehicle occupant in order to determine whether or not a certain airbag should deploy. The system detects the presence of an occupant by using low power microwaves in a short duty cycle targeted at an area of the vehicle corresponding to the location for which an airbag is to deploy.

U.S. Publication No. 2003/0179083 to Wallace et al. discloses a vehicle intrusion detection system for detecting an intrusion of the vehicle where an actuatable illuminator is mounted in the vehicle having a limited field of illumination extending within the vehicle occupant compartment and a linear imager mounted in the vehicle that has a field of view that coincides with the field of illumination of the illuminator and a controller comparing the first image taken by the imager when the illuminator is actuated and a second image taken by the imager when the illuminator is unactuated to help determine the existence of an intruder in the vehicle.

U.S. Pat. No. 5,805,055 to Colizza discloses an anti-theft system installed on a vehicle. The anti-theft system includes a weight sensor weighing the driver's seat. The weight sensor is in communication with a computer, and the computer stores the driver's weight and compares that weight with any weight placed upon the seat as measured by the sensor. Also included is a weight sensor on a load platform of the motor vehicle that can detect the load weight differences on the same load platform. Thus if the computer senses a change in the driver's weight or a predetermined decrease of weight on the load platform the alarm system will sound.

U.S. Publication No. 2005/0219042 to Thomson also discloses a vehicle alarm system that detects the changes in weight of a load carried by a vehicle. Specifically Thomson teaches detecting weight changes by using a sensor which measures the pressure within air suspension units, this pressure being a function of the weight carried within the cargo compartment. That weight is transmitted to a computer. The computer will store that weight and is in constant communication with the sensor. Thus when additional weight is added onto the cargo area or when weight is being removed from the cargo area the alarm will sound.

Accordingly none of the prior art above teaches a method for detecting an intruder in a vehicle is determined by detecting a change in the clearance between the vehicle and the ground. The prior art that does teach the detection of an intruder in a vehicle due to the change in the weight of the vehicle does so by using a sensor on specifically the seat itself or teaches the detection of an intruder in a vehicle using very complicated and expensive technology. Accordingly it is desirable to have a method for detecting the intrusion of a person in a vehicle using known sensors that are relatively cheap with respect to the teachings disclosed above.

### SUMMARY OF THE INVENTION

Provided is a system and method for detecting the presence of an intruder in a vehicle, the system comprising a computer, at least one sensor, and an alarm. The computer is in communication with at least one sensor, the sensor being capable of indirectly monitoring and measuring the weight of a vehicle, an alarm in communication with the computer, the alarm being triggered when certain predetermined events occur. Specifically the system detects a change in the vehicle's position with respect to the ground to determine if an intruder of a predetermined weight has entered the vehicle. In such an event, the alarm will be triggered. The sensor is a short range finder of the type known in use such as the E4C-UDA sensor made by Omron Co. Several of these sensors may be placed in various locations on the vehicle that provide said sensors with a clear line of sight to the ground. The sensors would measure the distance from its current location to the ground and transmit said distance to the computer and continually measure and report the distance of the sensor relative to the ground. When reported distance is shortened by a predetermined load placed in the vehicle then the alarm is activated.

A method for detecting the presence of an intruder in a vehicle consisting of the following steps: (1) establishing a base distance of the vehicle with respect to the ground when an intruder is not present, (2) detecting a change in the position of the vehicle with respect to the ground, (3) activating an alarm if the vehicle's position with respect to the ground decreases over a predetermined amount.

### BRIEF DESCRIPTION OF THE DRAWINGS

Advantages of the present invention are readily appreciated as the same become better understood by reference to the following detailed description when considered in connection with the accompanying drawings wherein:

FIG. 1 is a perspective of a vehicle having a system for detecting the presence of an intruder.

FIG. 2 is a perspective of the vehicle in a first condition where the base distance is measured and a second condition where an intruder has entered the cabin of the vehicle, and the present distance is computed, wherein the present distance plus the variable distance DDI is sufficient to activate the alarm.

FIG. 3 is a block diagram of the method.

FIG. 4 is a logic chart showing a first preferred embodiment of the method.

### DETAILED DESCRIPTION OF A PREFERRED EMBODIMENT OF THE PRESENT INVENTION

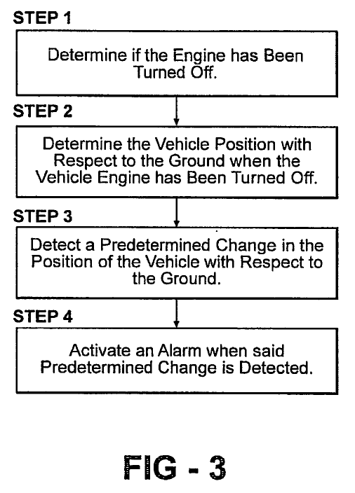

With reference first to FIG. 3 a method for detecting the presence of an intruder in a vehicle is provided. The first step of the method is to determine if the engine has been turned off. The next step in the method is to determine the vehicle position with respect to the ground when no intruder is present therein and the vehicle is turned off. This may be achieved using a sensor that can measure the distance to the ground. The next step is to detect a predetermined change in the position of the vehicle with respect to the ground, this can be achieved by talking subsequent measurements and comparing those measurements with the position of the vehicle with respect to the ground when no intruder is present within the vehicle and the engine is turned off. Finally, the last step is to activate an alarm when said predetermined change is detected. The intruder detecting method may also include steps to help prevent a false alarm by detecting the state of the doors of the vehicle and computing a present distance when the state of the doors have changed from an open to a closed position or if the state of the doors have not changed, after a predetermined period of time.

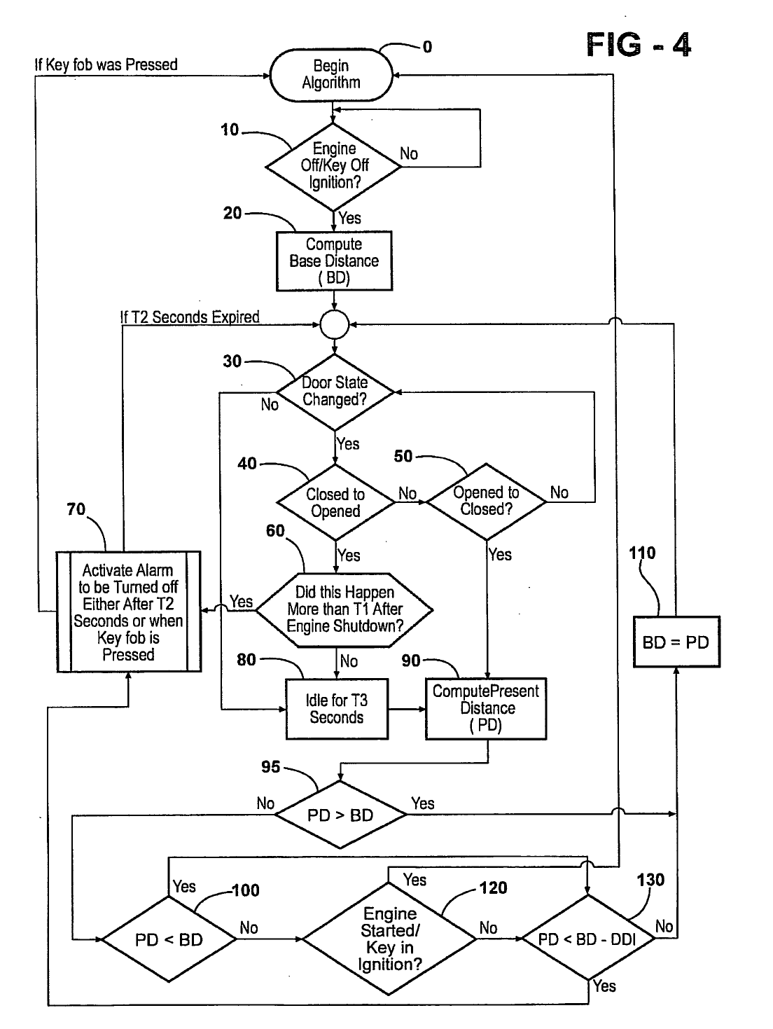

Now with reference to FIG. 4, a preferred embodiment of a method for detecting the presence of an intruder in a vehicle is provided. The method disclosed herein is directly related to measuring the weight of a vehicle and detecting if that weight has increased after the occupants have left the vehicle. Specifically, the method detects the presence of an intruder in a vehicle by determining if the weight of the vehicle has increased over a predetermined amount by using a change in the position of the vehicle with respect to the ground.

The method for detecting the presence of an intruder in a vehicle uses the clearance between a predetermined location of the vehicle and the ground to establish the natural weight of the vehicle without occupants therein. This inverse proportional relationship between the distance from the vehicle to the ground corresponds to the weight of the vehicle, accordingly in the event that an intruder enters the vehicle, the distance between said predetermined location and the ground is shortened. For instance a vehicle weighing several thousand pounds will have an established clearance between a portion of the vehicle and the ground, and additional weight added to said vehicle would decrease said clearance as the weight compresses the suspension and lowers said portion of the vehicle to the ground.

Accordingly a sensor to measure short distances of the type known in commercial use can be used. Such a sensor could be placed in a plurality of locations along the car. Preferably the sensor would be a short range detector having capabilities of detecting distances out to four feet. However, it is anticipated that a greater distance may be desired depending upon the size of the vehicle and the location of the sensor on the vehicle. The sensor should also have a measurement error commensurate with the vehicle suspension. For instance, in a vehicle with a tight suspension a measurement error below 5 mm may be appropriate. The E4C-UDA sensor is of the type and specificity within parameters described above. The E4C-UDA sensor has a range of three feet and a resolution (measurement error) of 1 mm. Although the E4C-UDA sensor is an ultrasonic sensor, it is anticipated that other types of range sensors could also be utilized such as a laser range finder, an imaging sensor or the like may also be used.

The sensor/s would be placed underneath a portion of the hood where the rangefinder would have a clear shot to the ground. That distance would then be measured to establish a base distance and a deviation of a certain amount from said base distance would trigger the alarm. To further increase the accuracy of the alarm, the base would be established after the completion of predetermined events such as, after the keys have been removed from the ignition, a state of the door has changed, or a predetermined amount of time has expired with all the doors remaining in a closed position. The base distance would then be computed using the sensors. A vehicle computer would store the base distance, and in the event that distance is lessened by a predetermined amount, the computer would activate the alarm system.

The method for detecting the presence of an intruder in a vehicle is shown in FIG. 4. The method begins by first establishing the base distance. Specifically this means determining the natural weight of the vehicle when all the occupants have left the vehicle. As a condition to this, other criteria may be imposed so as to mitigate the possibility of a false alarm. For instance, block 10 shows that the computer needs to determine if the vehicle has been turned off thereby allowing people to enter and exit the vehicle while the vehicle is still operating without triggering the intruder alarm. So, if a driver is on his way to pick up his kid from school the driver need not have to worry about the child entering into the vehicle and triggering the alarm.

After said condition is met, the next step is to establish a base distance which takes into account the weight of the vehicle to include any existing loads or packages or articles contained within the car as shown in block 20. Accordingly, computed base distances could differ. In one instance when a user is using the car to run errands and picks up groceries and then has to go to the post office to drop off mail, the base distance after the driver he has left the grocery store would be less than the base distance computed at the driver's house due to the added weight of articles such as groceries.

Computation of the base distance may be done by filtering the signals from the sensors to obtain a mean value either over a fixed length-window of a predetermined time or by using the exponentially weighted moving average. Thus the base distance is determined by obtaining the average value of the distance between the location of the sensor and the ground, as taken by the sensor over a predetermined period of time. The base distance may be further made accurate by applying a filter to the measurements taken by each sensor. If a measurement taken by the sensor does not pass through the filter, said measurement will not be used in computing the base distance. Thus, the filter further eliminates the possibility of faulty readings from the sensor in determining the base distance.

The method disclosed herein then proceeds to blocks 30 through 80 which are all directed at conditions established to further mitigate the possibility of a false alarm. Such conditions are meant for illustrative purposes only and are not limiting. It is anticipated that other conditions may be established to mitigate the possibility of a false alarm such as an alarm bypass input, detecting if the radio is operating, and the like. In the preferred embodiment conditions for mitigating a false alarm is directed at implementing currently used door sensors. Block 30 detects the positions of the vehicle doors to include the trunk. Such detection is accomplished using standard door sensors present in most vehicles which are normally powered when the key is in the ignition. These sensors inform the driver whether a door is ajar and can also inform the driver of when the door is closed.

If the door sensor detects that the position of a door has changed, a further inquiry is made as to whether the position of a door has changed from an open position to a closed position, or vice-verse as shown in block 40 and block 50. If a door changes state from a closed to an open position, then the method proceeds to block 60 and determines if a door was opened after a first predetermined period of time (T1). The first predetermined period of time (T1) being sufficient for all the vehicle occupants to have exited the vehicle. If a door was opened after a first predetermined period of time (T1) after the engine has been shut down, the method proceeds to block 70. Accordingly, a change in the state of the vehicle door from closed position to an open position is an indication of an intruder and the alarm is set off without having to detect the change in the base distance of the vehicle. Thus the alarm activates when the vehicle is turned off and someone tries to open a door after the first predetermined period of time (T1) has expired. In such an event, the alarm is disabled after a second predetermined period of time (T2). Additionally, the driver or user may disable the alarm using a remote or the like. If the second predetermined amount of time is allowed to expire, the method proceeds to block 30 to further detect the state of the door. If the alarm is disabled using a remote, then a new base distance is computed. Thus a driver or passenger of the vehicle is able to load the vehicle with articles, passengers, or the like without setting off a false alarm.

If the position of a door changes from a closed to an open position, within first predetermined period of time (T1). Then a third predetermined period of time (T3) must pass at block 80, after which the method continues to block 90 where a present distance between the sensors and the ground is computed. Thus when shortly after the engine is turned off, the occupant keeps the door open so as to move articles in and out of the vehicle the alarm will not sound. If however, after the engine has been shut off and the first predetermined period of time (T1) has expired, and a door is opened, the alarm will activate.

If the state of a door has not changed from a closed to an open, but from an open to a closed position, then the method proceeds to block 90 where the current position of the vehicle with relation to the ground is determined. Thus, if a driver or passenger of the vehicle shuts a door after the door has been opened following the engine being turned off, and the present distance is immediately computed. If the position of the door has not changed from an open to a closed position, then the method proceeds back to block 30.

If the state of the doors has not changed, the method proceeds to block 80 where a third predetermined amount of time (T3) is allowed to expire. Upon expiration of the third predetermined amount of time (T3), the method proceeds to block 90 where the current position of the vehicle with relation to the ground is determined.

Block 90 detects the current position of the vehicle after the base distance has been computed. Specifically block 90 computes the present distance between the sensors and the ground. The short range distance sensors continually or periodically measure the distance between the present location of the sensor with respect to the ground, and these measurements are filtered and averaged according to the methods described above. The present distance is compared to the base distance as shown in blocks 95 and 100.

A variance (DDI) is established. The variance (DDI) correlates to a predetermined weight which suggests the presence of an intruder. If the present distance is less than the base distance by the variance (DDI) and the engine is stilled turned off, then the alarm is set off as shown in block 120 and 130 respectively. If the present distance is greater than the base distance (i.e. a load was taken off the vehicle after a base distance was computed), as is determined in block 95, then the present distance is marked as the new base distance as shown in block 110. If the present distance is smaller than the base distance, as determined in block 100, then the distances are compared in block 130. If at block 130 the present distance and the variance are greater than the subsequent present distance then the alarm is activated at block 70, otherwise, the method returns through block 110 to detecting conditions established to further mitigate the possibility of a false alarm, beginning at block 30.

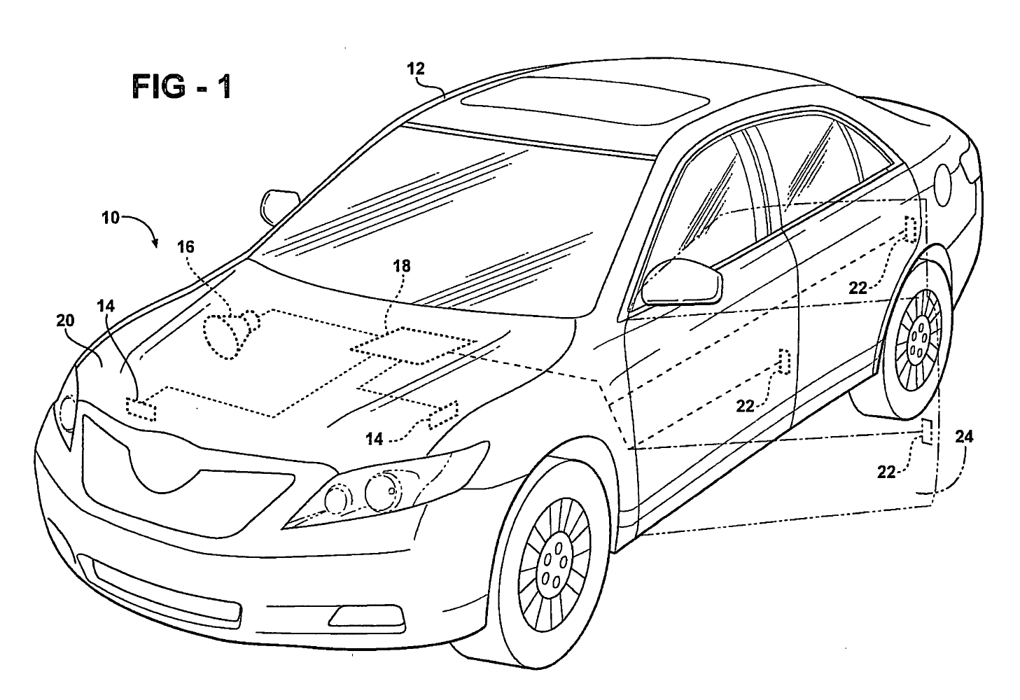

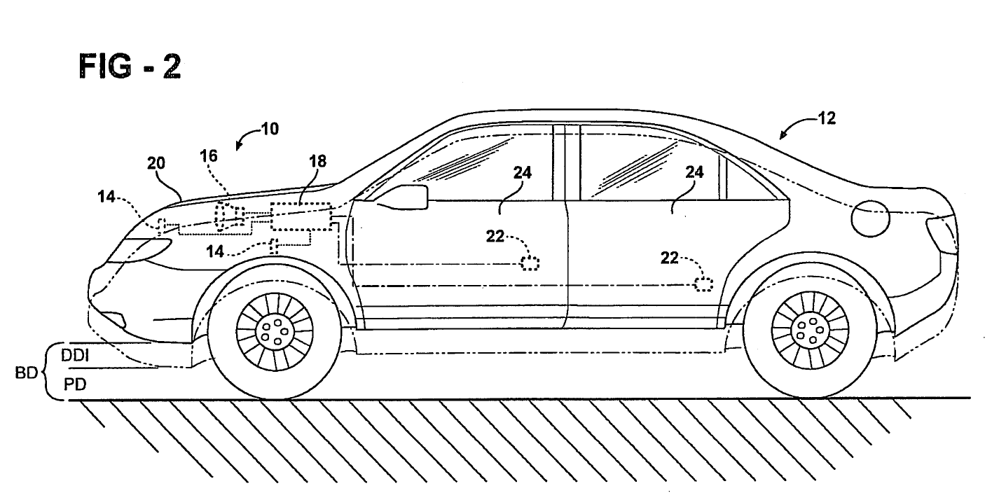

Now referring to FIGS. 1 and 2, a system 10 for detecting the presence of an intruder in a vehicle 12 is also provided. The system including at least one distance sensor 14, an alarm 16, and a processor 18. The distance sensors 14 may be placed in any location on the vehicle 12 where the sensor has a direct line of sight to the ground. Preferably, the sensors are disposed on the vehicle 12 such that the distance sensors 14 are hidden from plain view. Each distance sensor 14 measures the distance between the distance sensor 14 and the ground, and each is in communication with the processor 18, and transmits the measurements to the processor 18. The processor 18 may be a separate computer or the vehicle's on-board computer, and processes the measurements of distance using an algorithm. The algorithm includes a filtering function to exclude measurements which are false readings or bad readings such as negative values. For instance, the filter would exclude from its calculation a measurement from a distance sensor located on underside of a vehicle hood 20 and three feet from the ground that indicates that the distance sensor 14 is located 5 inches from the ground. Each distance sensor 14 takes a predetermined number of readings over a set period of time, these readings are processed by the computer using said algorithm to establish a distance.

Door sensors 22 may also be provided, the door sensors 22 detect the state of the doors 24 and communicate said state of the doors 24 to the processor 18 in order to prevent a false alarm. The processor 18 is also in communication with the alarm 16 The alarm 16 may be an audio sound such as a plurality of large beeps, flashing lights, or a combination of the two. Furthermore, the processor 18 may also disable the vehicle 12 when the distance sensors 14 indicate the presence of an intruder.

The system 10 detects the presence of an intruder in the vehicle 12 by detecting a change in weight of the vehicle 12. Specifically, the system 10 detects the change in vehicle weight by measuring the distance between a distance sensor 14 and the ground. As stated above the distance sensors 14 provide the processor 18 with measurements of the distance between the distance sensors 14 and the ground. These measurements are processed by the computer using an algorithm to compute a distance. The computation of a base distance is made when a set of conditions have been fulfilled such as the engine has been turned off. The value of that base distance is then stored in the processor 18 and later compared with subsequent computations using the same distance sensors 14, these subsequent computations determining a present distance between the distance sensors 14 and the ground.

Computation of the present distance is not made until a certain conditions have been met that are directed at preventing a false alarm. For instance, it may be desirable to wait before computing a present distance until after a set period of time has expired after the engine has been turned off, and the door sensors have detected that the doors 24 have gone from a closed state to an open state and back to a closed state. Alternatively, present distance computation may be initiated by a vehicle user by pressing a key fob to ready the alarm. After the present distance computation has been initiated, the processor 18 compares the computed present distance with the base distance. If the distance sensors 14 detect a change in the distance to the ground, a new present distance is computed, which is also compared with the base distance. If any computed present distance is less than the base distance by a predetermined length, then the alarm 16 is activated. If the computed present distance is greater than the computed base distance, then said present distance becomes the base distance upon which subsequent present distances are compared. Accordingly, a system 10 using well known distance sensors 14 to detect the presence of an intruder in a vehicle 12 is provided.

1. A method for detecting the presence of an intruder in a vehicle comprising:
determining if the engine has been turned off;
determining the vehicle position with respect to the ground when no intruder is present therein and the vehicle is tamed off;
detecting a predetermined change in the position of the vehicle with respect to the ground; and
activating said alarm when said predetermined change is detected.

2. A method of claim 1 wherein, at least one sensor detecting distance measures the distance from the at least one sensor to the ground.

3. A method of claim 2 wherein a processor receives the measurements and processes said measurements to compute a base distance.

4. A method of claim 3 wherein said at least one sensor continues to provide measurements to said processor after said base distance has been computed to compute a present distance, said processor further comparing said base distance to said present distance and activating the alarm when the difference between said present distance is equal or lesser than said predetermined change in position.

5. A method of claim 4 further including detecting the state of the doors of the vehicle and computing a present distance when the state of the doors have changed from an open to a closed position or if the state of the doors have not changed, after a predetermined period of time.

6. A system for detecting the presence of an intruder in a vehicle using the change in the position of the vehicle with respect to the ground as a result of the intruder entering said vehicle, said system comprising:
an alarm,
a computer, said computer in communication with said alarm; and
a sensor, said sensor detecting a first distance between said sensor and the ground, and detecting a plurality of subsequent distances between said sensor and the ground when said vehicle is turned off, said sensor in communication, and said computer comparing said first distance to each of said plurality of subsequent distances and activating said alarm when one of said plurality of subsequent distances is lesser than said first distance by a predetermined amount.

7. A system of claim 6 further comprising a door sensor, said door sensor detecting the state of the vehicle doors, and in communication with said computer, wherein said computer does not activate said alarm when said vehicle doors are in a predetermined state.
